(19) United States
(12) Patent Application Publication
(10) Pub. No.: US 2002/0059604 A1
(43) Pub. Date: May 16, 2002

(54) System and method for linking media content

(76) Inventors: Kenneth M. Papagan, Los Angeles, CA (US); Dale Alan Herigstad, Holly Wood, CA (US)

Correspondence Address: HUNTON & WILLIAMS, ATTN: JONATHAN D. LINK, 1900 K STREET, N.W., WASHINGTON, DC, 20006, US

(21) Appl. No.: 09/853,665

(22) Filed: May 14, 2001

Related U.S. Application Data
(63) Continuation of application No. 09/664,612, filed on Sep. 18, 2000.
(60) Provisional application No. 60/154,218, filed on Sep. 16, 1999.

(51) Int. Cl. G06F 3/00

(52) U.S. Cl. 725/51

(57) ABSTRACT

A system and method for providing linked media content for interactive broadcast over a network. The system includes a presentation device for displaying streaming content and a selector for indicating interest in related media content. The method includes viewing a streaming media object, identifying a portion for indicating interest in related media content. A data source for linked media objects is also disclosed.

### RELATED APPLICATIONS

This application is a conversion of U.S. provisional application serial No. 60/154,218 entitled “INTERACTIVE TELEVISION SYSTEM” filed on Sep. 16, 1999, incorporated by reference.

### FIELD OF THE INVENTION

The invention relates generally to a system and method for media creation and publishing, and more particularly, to indexing and linking media for presentation to a user.

### BACKGROUND OF THE INVENTION

Creation and distribution of media is undergoing radical transformation. Digital technology allows media to be produced, distributed, and experienced with far greater speed and flexibility than ever before. The growth of broadband distribution channels and the Internet as a mass medium is expanding the way media reaches audiences. New distribution mechanisms, such as the Web, digital cable, digital broadcast, and IP satellite, and new devices for accessing media, such as interactive televisions, specialized Internet appliances, cellular telephones, and personal digital assistants are redefining peoples relationships with the media they consume.

The Internet is fast becoming an important source of news, information, and entertainment for many people. The Internet is feeding a paradigm shift in media consumption from the passive receiver model of traditional radio and television broadcast, toward a more interactive two-way broadcast model. Interactive television, targeted advertising through networked devices (from automatic teller machines to refrigerators), real-time information through personal communication devices, and other emerging technologies will also provide outlets for rich interactive media.

Interactive media, from Web sites to interactive television, provide information about events, products, services, advertisements, and announcements, among other things, in a variety of formats, such as images, streaming video, text, audio, and other manners. Effective interactive media may combine a number of media objects produced in one or more formats into an integrated multimedia presentation.

Present methods for creating and presenting multimedia presentations over the Internet and other channels of interactive media may suffer from the drawback of being difficult, time intensive, and costly to create. Once created, Internet multimedia presentations may be difficult to present to a number of viewers in a number of formats. Porting multimedia presentations between various distribution channels and end user devices may be difficult. Component media objects may be difficult to identify and manage for reuse.

The combination of streaming media with other media content (including other non-sequential streaming media) may present challenges for ease of navigation and presentation continuity. Existing technologies for combining other media objects with streaming media involve providing a secondary interface (e.g., frame, control panel, pop-up window, etc.) for navigating other media objects and may involve interruptions to the streaming media.

These and other drawbacks may exist.

### SUMMARY OF THE INVENTION

An object of the invention is to overcome these and other drawbacks in existing systems and methods.

Another object of the invention is to provide a system and methodology for enabling a user to create media content once and allow presentation of a multimedia presentation to a number of users.

Another object of the invention is to provide a system and methodology for linking media content for presentation to a user.

Additional objects and advantages of the invention will be set forth in part in the description, or may be learned by practice of the invention. The objects and advantages of the invention may be realized and attained by means of instrumentalities and combinations particularly pointed out in the appended claims. These objects, in accordance with the purpose of the invention, as embodied and broadly described herein, are particularly achieved by a system for providing interactive programs including linked media content. The system includes a presentation device, such as an interactive television, and a selector, such as a remote control. The presentation device renders a number of media objects for the user, including at least one media object that includes streaming media. The selector is used for selecting a portion of the streaming media that is associated with a link to related media objects.

These objects may also be achieved by a method for navigating an interactive broadcast including linked media content. The method includes the steps of viewing a streaming media object, identifying a portion of interest in the to streaming media object, and accessing an interface for viewing related media objects based upon links associated with the identified portion of interest.

These objects may also be achieved by a data source including a linked media object for distribution over a network. The data source may include media content for the media object, content descriptive metadata for the media object, and a number of associated media objects.

The accompanying drawings, which are incorporated in and constitute a part of this specification, illustrate an embodiment of the invention and, together with the description, serve to explain the principles of the invention.

### BRIEF DESCRIPTION OF THE DRAWINGS

FIG. 1 is a flowchart illustrating the steps of the process for creating and publishing media content according to an embodiment of the invention.

FIG. 2 is a schematic diagram of linked media objects according to an embodiment of the invention.

FIG. 3 is a schematic diagram of a system of delivering linked media objects according to an embodiment of the invention.

### DETAILED DESCRIPTION OF THE PREFERRED EMBODIMENTS

Reference will now be made in detail to a present preferred embodiment of the invention, an example of which is illustrated in the accompanying drawings, in which like reference characters refer to corresponding elements.

Before the invention is described in detail, an example will now be described to illustrate an embodiment of the invention. In this example, a user may be viewing a media presentation about a cooking show having interactive components, such as a television program, where the television has a set top and control for enabling the user to interact with the interactive components of the television program. Specifically, a user may be able to interact with the cooking television program.

By way of this example, a user of the present invention may view information and links located within the television program. A user may access a recipe associated with a portion of the cooking television program. The user may print the recipe out at the time it is accessed, or may save the recipe for later retrieval. A user may also access a link to a food delivery web site. Using the food delivery web site, the user may order the ingredients for the recipe and those ingredients delivered. Further embodiments and examples of the present invention will now be described.

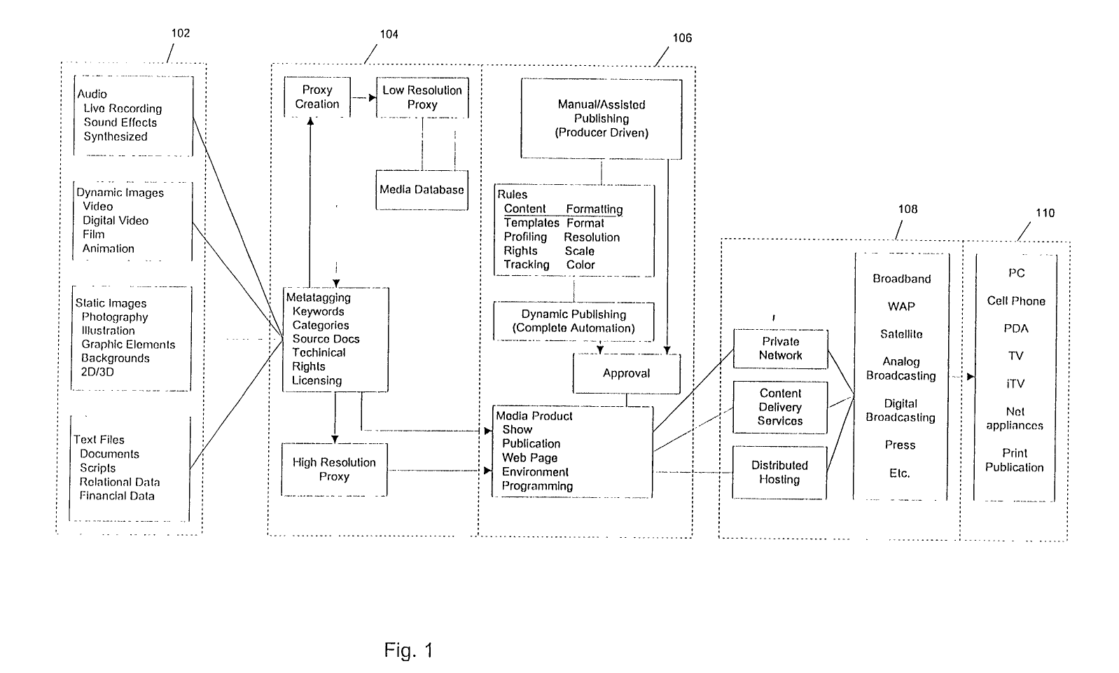

FIG. 1 is a flowchart illustrating the steps of the process for creating and publishing media content according to an embodiment of the invention. At step 102, a plurality of media objects are created out of media data. At step 104, the various media objects are managed. The multimedia presentation is published at step 106, and distributed at step 108. Publishing the media objects includes assembling the plurality of media objects to form at least one multimedia presentation including linked media objects. At step 110, the multimedia presentation is presented. The flow chart of FIG. 1 will be described in greater detail below.

At step 102, media objects are created from media data. According to an embodiment of the invention, standard creating software and/or custom code may be used to create the media content. Media data may be any data, information or material used for creating media objects. Media data may include audio (e.g., live recording, sound effects, synthesized sounds, etc.), dynamic images (e.g., video, digital video, film animation, etc.), static images (e.g., photographs, illustrative, graphic elements, backgrounds, two and three dimensional images, etc.), text (e.g., documents, scripts, relational data, financial data, etc.), or any material that a user desires to assemble into a multimedia presentation. Media objects may include a single type of media data or may include a variety of different types. Media objects may contain other media objects. Media objects may also include non-linear flow logic (e.g., using hyperlinks, tags, or other methods for directing presentation flow). Media objects may include interactive flow logic to provide user defined navigation of the media content within the media object. Navigation tools may be imbedded within the media objects or may be provided through compatibility with presentation applications (e.g., a Web browser, media player, interactive television application, or other application for the presentation of digital content).

By way of example, a user may take analog audio and video files (e.g., media data) and convert them to digital audio and video files (e.g., media objects) to be stored on a processor. A user may convert pictures and film to a digital format for presentation in a digital format, and perform frame capturing on portions of a digital film to obtain static images. By way of example, a user may employ Virage® creation software to create media objects.

At step 104, the user manages the media objects. According to an embodiment of the invention, managing media objects may comprise organizing media objects for later assembly into a multimedia presentation, such as an Internet multimedia presentation or an interactive television program. In one embodiment, managing media objects may include linking a variety of media objects into an interactive program. A user may search the media object database to find the appropriate media objects for a media presentation. Standard management software, or customized developed management software may be used. By way of example, the T.E.A.M.S.® management software may be used to read data produced using the Virage® creation software.

Using such management software with media objects and media data, whether standard software or custom developed software, searches may be performed, the version of a particular media objects may be altered and/or controlled, or other functions related to management may be performed.

According to an embodiment of the invention, media objects may include metadata associated with the media object and/or various aspects of the media object and media data within the media object. Metadata tagging may include tags associated with specific portions of a media object. Metadata may include descriptions of media object content, format, subject matter, authorship, ownership, user rights, navigation tags, and other data. Metadata may be integrated into the media object itself or provided through an associated data source (e.g., a metadata database indexed by media object identifiers). By way of example, metadata produced by a standard creation software program, such as Virage®, may be stored on an Oracle 8I database. Storing media objects may permit a user to later access the media content, including use in other multimedia presentations.

Managing media objects may also include search capabilities and extensions of metadata tracking and capturing of stored media content. Once media content is created and stored, a user may search for the content for later multimedia presentations.

In one example of step 104, a documentary on classic automobiles may be created as a plurality of media objects. A series of interviews and video sequences may be recorded on location at a classic car show using traditional analog video equipment. Those interviews and video sequences may be converted to digital format, edited, and linked into a sequential framework. A title sequence and credits may be created using a computer program and placed in appropriate places in the sequential framework. The documentary media object may be provided with a unique identifier and metadata descriptive of the content, format, authorship, and other information. Metadata may also be added to describe various portions of the documentary, such as each scene or even each frame of the documentary. The documentary media object, including the associated metadata, may be saved in a media object data source for later use. Unused and/or unedited portions of the interviews and video footage, research materials, and other media data that are not contained in the documentary media object may be saved as additional media objects, with appropriately descriptive metadata.

At step 106, the multimedia presentation is published. According to an embodiment of the invention, publishing the multimedia presentation may comprise publishing the multimedia presentation as well as indicating the availability of the multimedia presentation. Standard publishing software and/or custom developed publishing software may be used to publish the multimedia presentation. By way of example, ATG Dynamo® publishing software may be used with the present invention.

A user may use publishing software to assemble media objects into one or more multimedia presentations. A user may assemble media objects, such as video, audio, graphics, text, and other content into a single multimedia presentation, such as a single “RM file” for a Real Player® video player. Using publishing software to assemble a mulitmedia presentation may include not only assembling media content, but also assembling advertising, providing commerce functionality (e,g, product ordering and payment functions), and providing enhanced information. According to an embodiment of the invention, a user may provided interactive functionality in a multimedia presentation, where the viewer of the presentation may interact, thereby customizing the presentation to the viewer's taste.

Publishing software may also provide the ability for a user of the present invention to automatically assemble multimedia presentation, moved a multimedia presentation to an accessible network location, add to “available shows for scheduling,” and provide stages for multimedia presentation for channel publishing.

One example of step 106 is the publishing of a media presentation including linked media objects. For example, an interactive television program may be assembled to provide a core video stream with associated text, video, audio, e-commerce, and advertising content to be accessed by user's interested in the interactive functionalities. To continue the example from step 104 regarding the classic automobile documentary, the documentary media object may be identified to provide the core video stream for an interactive television program. A search of a media object may also identify the fill length versions of the interviews, unedited video sequences from the car show, research materials including detailed written descriptions of various cars featured in the documentary, and other related content. These conceptually related media objects may be used to assemble the linked interactive content of the interactive television program. By inserting links, into the metadata associated with various portions of the core documentary media object, the additional media objects may be associated with an appropriate portion of the documentary media object. Alternatively, the associated data objects may be bundled with the core documentary media object and an appropriate application for retrieving associated materials, such as one which identifies media objects related to the portion of the core media object based upon comparisons between metatag descriptions of the associated object and the metadata description of the core media object portion.

Using the publishing software, a user also may associate certain commerce items with one or more multimedia presentations. By way of an example, a user may associate sporting equipment with a multimedia presentation about sports. While watching the professional hockey championship, hockey merchandise, such as equipment, jerseys, and souvenir items, may be associated with the presentation and made available to the viewer. Additionally, dynamic rules may be created to optimize the content on the multimedia presentation.

According to an embodiment of the invention, publishing software may enable a user to schedule presentations of one or more multimedia presentation, create on-demand directory, send channel rundowns to broadcast manager, and send channel guides to channel distribution systems. Scheduling a multimedia presentation for presentation to a user may comprise moving a presentation from staging into timeslots in channel rundown. Moving a multimedia presentation may be performed by a variety of methods, such as designated a location for the multimedia presentation to be moved, or using a web based drag and drop interface.

Creating an on-demand directory may comprises tagging shows in staging for on-demand availability. Tagging multimedia presentations may result in the shows inclusion in a hierarchical directory of on demand content for a program guide.

One example of step 106 is publishing an interactive television program to one or more interactive television networks. To continue the classic example of automobile documentary, media presentation of the documentary may be identified as available for distribution. Plot summaries, content samples, advertising materials, and other media objects may be linked to the media presentation object and/or made available to the interactive television networks for review and use in promotion of the program. Metadata for the publication media object may include terms of use for the publication media object. The publication media object may include metadata tags for identifying locations in which advertising, custom content, or other content may be inserted into the publication media object during presentation.

At step 108, the user distributes one or more multimedia presentations. According to an embodiment of the invention, distribution software may enable the user to distribute the multimedia presentations to various servers for further distribution to viewers such as through public or private networks, content delivery, services, or distributed hosting. Distribution software may be any standard distribution software and/or custom developed distribution software. By way of example, Real Studio Producer® may be used to distribute the multimedia presentation.

The distribution software enables the acceptance of channel rundowns from Broadcast Automation System, Unicast live and pre-produced content to high availability streaming media servers on edge-node distribution network. Channel distribution servers accept program guide data from channel publishing system, thereby generating a play list for a viewer at an end viewer device. The play list allows a viewer to obtain information about one or more multimedia presentations, and select the desire multimedia presentation from the channel distribution system. The play list may include dates and times the multimedia presentation is available (e.g., when a live event is held), the run time for the multimedia presentation, a summary of the multimedia presentation, and other information.

According to an embodiment of the invention, a user may enable interaction between viewer and the multimedia presentation, as well as the system of the present invention. A viewer may receive messages during event management system, such as advertisements, or messages from other viewers. Additionally, a view may set reminders, such as a reminder that a particular multimedia presentation is available. Messages and reminders may be in any type of format, including, but not limited to, audio, video, text, or graphics.

The distribution software may also provide updates to channel schedules, such as when the availability of a multimedia presentation changes. Further, the system may switch between live and pre-produced multimedia presentations on the fly. By way of example, during a live sporting event, the system may switch to a pre-produced commercials during a stoppage of time.

The channel distribution system synchronizes local files tagged for on-demand availability with remote file systems on Broadband Distribution Network. The system may also show on the air XML generator.

As an example of step 108, an interactive television program may be distributed to a plurality of interactive television networks or network servers. To continue the classic automobile documentary example, the publication media object may be provided to a number of network servers to be distributed according to a number of different presentation schedules and formats. For example, the classic automobile network may place the documentary in its standard line-up for presentation at 8:00 pm Sunday evening. The classic automobile network also maintains a Web site and a Web server capable of providing on demand Web casts of the documentary.

At step 110, the multimedia presentation is presented to the viewer. According to an embodiment of the invention, a viewer may use standard presentation software and/or custom developed presentation software to view the multimedia presentation. By way of example, a Real Player®, Microsoft Internet Explorer® 5, and/or a flash plug in may be used to view a multimedia presentation.

The presentation software may include an installer component to ensure that the viewer has the proper tools to view a multimedia presentation. By way of example, a user selects a multimedia presentation in a Real Player® format. The installer component scans the tools resident on the end viewer device to ensure that the multimedia presentation can be properly viewed. The installer may then load and install Real Player®, if necessary, thereby allowing the viewer to view the multimedia presentation.

The presentation software may also include a channel selector for allowing the viewer to manipulate a channel play list. A view may obtain information about multimedia presentations, and select the desired multimedia presentation for presentation at the end viewer device. The presentation software may also serve as an end user viewer manager, enabling an end viewer device, and therefore the viewer, to indicate which multimedia presentations are on the air and which are on demand, to receive and interact with commerce elements of the multimedia presentation (e.g., view information about a product and purchase the product), to log-in to the channel distribution system, and to use other features.

As an example of step 110, a user, on demand or according to a broadcast schedule, may view an interactive television program. In the classic automobile documentary example, a viewer tunes in to the classic car network on their interactive digital television at 8:00 pm on Sunday night. She views the streamed documentary media object as rendered by the interactive television applications. At various points throughout the program an icon indicates the availability of additional content. The viewer uses buttons on her remote control for accessing and/or storing links to the associated media objects during portions of the documentary that interest her. Simultaneously, through a sub-interface (such as a frame or window), or after the program, through an alternate interface (such as an interactive content manager channel), the viewer views a full length interview with the designer of a car model she particularly liked and accesses text describing the details of the model. A banner advertisement for a local hobby shop carrying plastic models of car she liked may be provided upon accessing the additional media objects, and a video advertisement media object for manufacturers of replica car kits is inserted at the end of the complete interview.

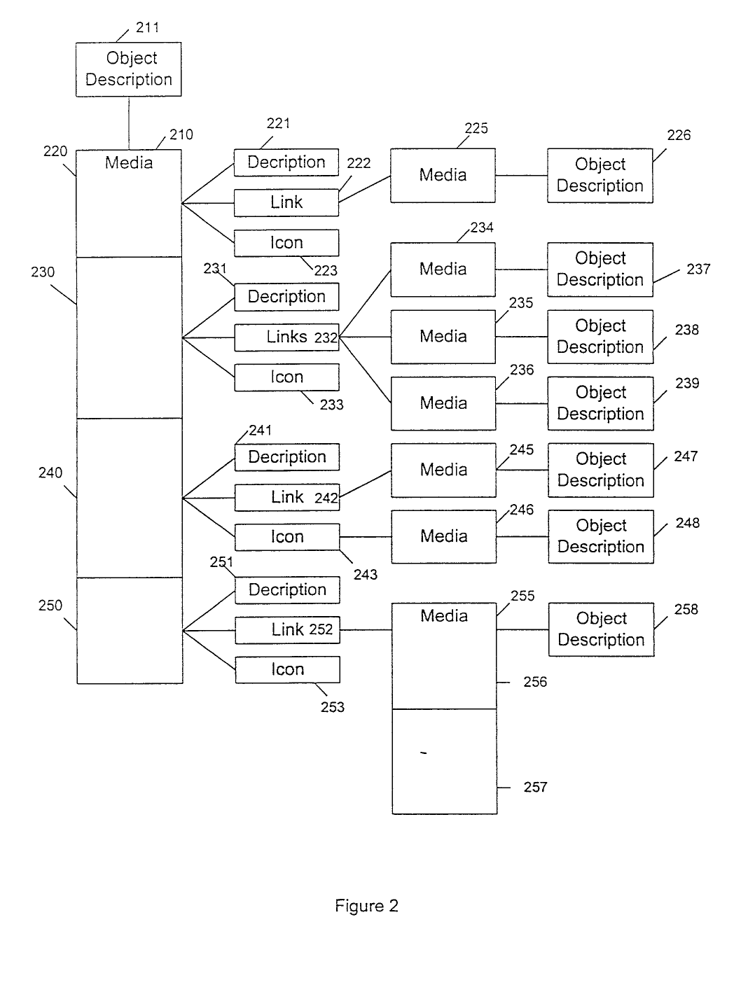

FIG. 2 shows linked media objects according to one embodiment of the invention. Media object 210 is a core media object to which other media objects have been linked. Media object 210 may be associated with metadata (e.g., Object Description 211, portion Description 220, etc.) and other media objects (e.g., Media objects 225, 234, etc.). The other media objects may in turn be associated with additional metadata (e.g., Object Descriptions 226, 237, etc.).

Media object 210 may be any type of media object, including any type or types of media content or media data. In one embodiment, Media Object 210 may include streaming media content or other media data for sequential presentation. In one embodiment, Media Object 210 may include a number of portions, such as portions 220, 230, 240, and 250. Portions 220, 230, 240, and 250 may include segments, frames, tracks, or other separable media content or media data divisions. In one embodiment, portions 220, 230, 240, and 250 may be based upon other media objects. In one example, Media object 210 may be a video documentary and portions 220, 230, 240, and 250 may be time separable divisions, such as conceptual segments or scenes. In an alternate example, each of portions 220, 230, 240 and 250 may be individual video frames.

Metadata associated with Media object 210 may include metadata associated with the object as a whole (e.g., Object Description 211) and/or metadata associated with any portion of the object (e.g., portion Description 221). Object Description 211 may include data describing Media object 210 as a whole. In one embodiment, Object Description 211 may include an object identifier, content description, data format description, subject matter description, creation date, source description, authorship information, ownership information, terms of use information, and other information. In one embodiment, Object Description 211 includes identifiers for any identified portions in Media object 210 (e.g., portions 220, 230, 240, and 250). Metadata may also be associated with each portion of Media object 210. For example, portion 220 may be associated with a Description 221, a Link 222, and an Icon 223, portion 230 may be associated with a Description 231, Links 232, and an Icon 233, portion 240 may be associated with a Description 241, a Link 242, and an Icon 243, and portion 250 may be associated with a Description 251, a Link 252, and an Icon 253. Descriptions 221, 231, 241, and 251 may include data descriptive of the respective portions analogous to Object Description 211 for Media object 210. Links 222, 232, 242, and 252 may include links, pointers, locators, tags or other manners for locating associated media content. For example, Link 222 may include a resource locator for Media object 225.

Links 232 may include a subject tag whereby a media locator application (e.g., a search engine) may locate associated Media objects 234, 235, and 236 (e.g. by matching metatags). Link 242 may include a pointer to a file containing Media object 246. Link 252 may include a link to a directory indexing Media object 255. Icons 223, 233, 243, and 253 may include icons for display to a user for accessing linked media content. In one embodiment, icons may include a static or dynamic icon as are used in many computer systems for denoting a link or shortcut to an application, function, or file. In one embodiment, icons may include a sample from the portion of Media object 210, such as a video frame or loop of video frames. In one embodiment, icons may be dynamically generated during presentation. In one embodiment, an icon, such as Icon 243, may include a separate Media object 246 to be used as an icon. For example, a video segment (e.g., a promotional segment) incorporating at least part of portion 240 and/or a portion of Media object 245 may be included in Media object 246.

Associated media objects (e.g., Media objects 225, 234, etc.) may be any type of media object containing any type of media content and/or media data. Associated media objects may include object descriptions (e.g., Object Descriptions 226, 237, etc.) similar to Object Description 211. As shown for Media Object 255, associated media objects may include identified portions (e.g., portions 256 and 257). Associated media objects may in turn be linked to additional media objects as described above for Media object 210. Nested linking may provide a wealth of navigational options for multimedia presentations. Media objects may link back to their own portions, back to a core Media object, or in any other configuration.

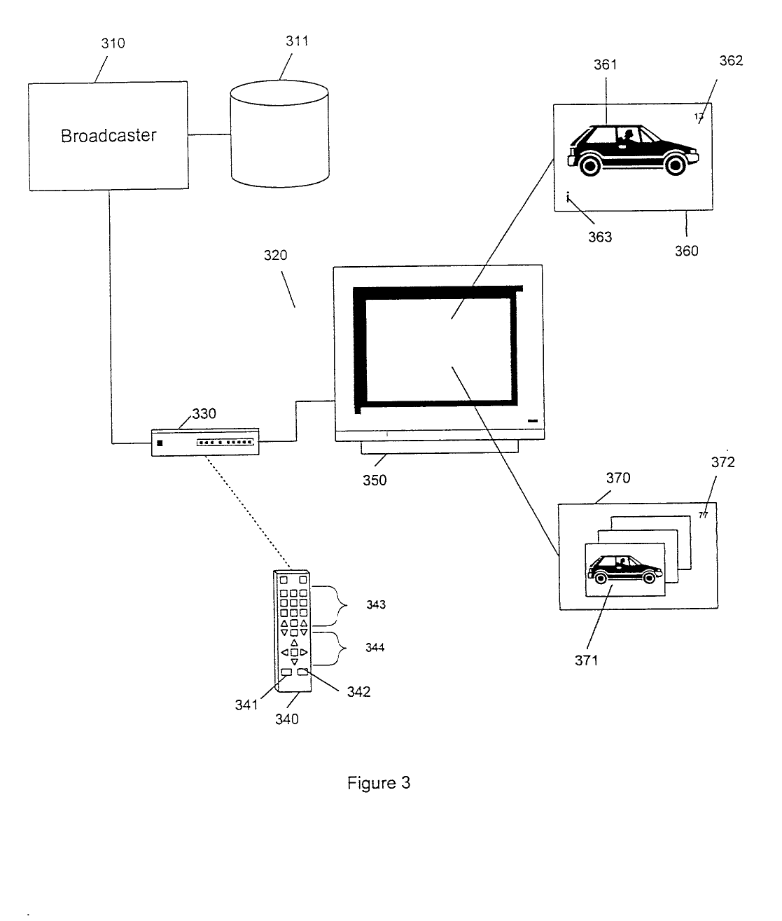

FIG. 3 shows a system for delivering linked media content according to an embodiment of the invention. In one embodiment, a media object may originate from Broadcaster 310 and be communicated to a presentation device 320. Broadcaster 310 may retrieve the media object from a media data source 311. Presentation device 320 may include a computer 330, a selector 340, and a display 350. Example interfaces from display 350 are shown as interfaces 360 and 370.

Broadcaster 310 may be any system for distributing a media object. In one embodiment, Broadcaster 310 may include one or more servers for communicating a plurality of media objects. For example, Broadcaster 310 may include a digital programming server, a local carrier gateway server, and/or one or more additional servers (e.g., advertisement servers, interactive content servers, etc.). Broadcaster 310 may be capable of pushing media objects on a pre-defined schedule, similar to traditional broadcast media, pushing media objects on demand received from a remote viewer or presentation device 320, or providing interactive media objects based upon exchange with presentation device 320. Broadcaster 310 may distribute media objects using Internet protocols (e.g., via the World Wide Web), digital cable, digital broadcast, IP satellite, and/or other digital distribution channels.

Media data source 311 may be any number of data sources containing one or more media objects or a portion thereof. In one embodiment, Media data source 311 may include a database of media data and associated metadata. Media data source 311 may include a hierarchical organization and retrieval system, a search engine, or other applications for retrieving desired media objects. In one embodiment, media data source 311 includes distributed media objects located within a plurality of networked data sources.

Presentation device 320 may include any device for rendering digital media objects. Presentation device 320 may include personal computers, Internet appliances, interactive/digital televisions, interactive/digital radios, personal communication devices (e.g., cellular telephones, two-way radios, personal digital assistants, portable e-mail systems, etc.), networked appliances (e.g., refrigerators, coffee makers, stereo systems, etc. on home networks), automatic teller machines, on-board computers for automobiles, or any other device for providing interactive digital media. Presentation device 320 may include an output device (e.g., speaker, display, television, etc.), an input device (e.g., keyboard, microphone, remote control, or any other selector), a microprocessor, and at least one memory system. The example presentation device 320 shown is an interactive television, including computer 330, selector 340, and display 350.

Computer 330 may be a digital television set top box. In one embodiment, computer 330 may be built in to display 350 (e.g., digital ready television). Alternatively, computer 330 may include a personal computer or any other system including a microprocessor and memory system. In one embodiment, computer 330 includes one or more applications for rendering media content broadcast from Broadcaster 310 on display 350. In one embodiment, computer 330 includes on or more applications for receiving input from a user, such as through selector 340.

Selector 340 may be a remote control. Alternatively, selector 340 may include any input device for identifying user selection of media content associated with the media content presently displayed. In one embodiment, selector 340 may include a sonic trigger (e.g., voice recognition system), a remote or wired controller, a mouse, keyboard, joystick, a tracking system, or any other device for making a selection. In one embodiment, selector 340 includes a grab button 341 for selecting, but not displaying, media objects associated with the media content presently displayed on display 350. In one embodiment (not shown), grab button 341 is labeled “grab.” In one embodiment, selector 340 includes a more button 342 for selecting and displaying media objects associated with the media content presently displayed on display 350. In one embodiment (not shown), more button 342 is labeled “more.” In one embodiment, time compensation may be provided between a change in displayed content and the use of selector 340. In one embodiment, selector 340 may also include television controls 343 and navigation controls 344. In one embodiment (not shown), selector 340 may be a universal remote control.

Display 350 may be a television. Alternatively, display 350 may be any device for presenting digital media, such as projectors, speakers, monitors, or any other display device. Interfaces 360 and 370 may be presented on display 350.

Interface 360 is an example of an interface for viewing a media object, such as an interactive television program. Media content 361 is presented on display 350. Channel indicator 362 displays the channel presently displayed on display 350. Indicator 363 indicates that media content associated with the presently displayed content is available. In one embodiment, use of selector 340 may allow a viewer to indicate interest in associated media content. For example, pressing grab button 341 may save one or more icons and links associated with the presently displayed content. An alternate interface, such as interface 370, may be accessed to present the related content. Pressing more button 352 may immediately display associated content. The associated content may be displayed in an frame or window interface while continuing to display the original media content, may be displayed on an alternate display device, or may access an alternate channel for displaying the associated content.

Interface 370 may allow a user to access related media objects based upon previously selections. Interface 370 may include a plurality of icons 371 associated with media objects including related content and/or the original media object. The plurality of icons 371 may represent a plurality of selections previously made. In one embodiment, icons 371 include one or more frames from the original media object which were displayed near in time to selection with selector 340. In one embodiment, icons 371 may appear in a stack configuration. The icon on top of the stack may include active media (e.g., video, audio, etc,) associated with the media object to which it links or the media object from which it was selected. For example, the icon on the top of the stack may continuously stream a video loop extracted from the original media object. In one embodiment, icons 371 may be separate media objects. Interface 370 may also include a channel indicator 372. In one embodiment, interface 370 may be accessed by selecting an appropriate channel. In one embodiment, interface 370 may automatically be presented through a sub-interface, such as picture in a picture.

Other embodiments, uses and advantages of the present invention will be apparent to those skilled in the art from consideration of the specification and practice of the invention disclosed herein. The specification and examples should be considered exemplary only. The intended scope of the invention is only limited by the claims appended hereto.

What is claimed is:

1. A system for providing interactive programs including linked media content comprising:
a presentation device for rendering a plurality of media objects to a user, said plurality of media objects including a first media object including streaming media; and
a selector for selecting a portion of the first media object, the portion associated with a link to a related second media object.

2. The system of claim 1, wherein said presentation device includes a television and a computer for rendering interactive media.

3. The system of claim 1, wherein the selector includes a remote control with a button that selects the portion of the first media object streaming when the button is depressed.

4. The system of claim 1, wherein the link to the related second media object is included in metadata associated with the portion of the at least one streaming media object.

5. The system of claim 1, wherein the portion of the at least one streaming media object is a frame.

6. The system of claim 1, further comprising an interface for selectively accessing the second media object through an icon associated with the portion of the first media object selected.

7. The system of claim 6, wherein the interface includes a plurality of media objects associated with a plurality of portions of at least one other media object and wherein a user may selectively access the plurality of media objects through a plurality of icons associated with the plurality of portions of the at least one other media object.

8. The system of claim 6, wherein the portion of the first media object selected is a frame and the icon includes the frame.

9. The system of claim 6, wherein the icon includes a streaming media loop including the selected portion of the first media object.

10. The system of claim 1, further comprising a remote broadcast center for distributing the first media object and the second media object to said presentation device.

11. A method of navigating an interactive broadcast including linked media content, comprising the steps of:
viewing a first streaming media object including a plurality of portions associated with a plurality of related media objects;
identifying a portion of interest in the first streaming media object; and
accessing an interface for viewing a related media object through the link associated with the identified portion of interest.

12. The method of claim 11, wherein the step of viewing the first streaming media object includes viewing an interactive television program displayed on a presentation device including a television and a computer.

13. The method of claim 11, wherein the step of identifying a portion of interest includes using a selector to identify the portion of interest while the portion of interest is being displayed.

14. The method of claim 11, wherein viewing the first streaming media object is uninterrupted by the step of identifying the portion of interest.

15. The method of claim 11, wherein the step of accessing an interface for viewing includes selecting a channel other than a channel streaming the first streaming media object.

16. The method of claim 11, further comprising the step of browsing through a plurality of icons associated with a plurality of identified portions of interest.

17. A data source including a linked media object for distribution over a network comprising:
media content for the media object;
content descriptive metadata for the media object; and
at least one associated media object linked to a portion of said media content.

18. The data source of claim 17, further comprising icon descriptive metadata associated with the portion of said media content for the media object.

19. The data source of claim 18, wherein said icon descriptive metadata includes the portion of said media content.

20. The data source of claim 18, wherein said icon descriptive metadata includes a link to an icon media object.

21. The data source of claim 17, wherein said media content for the media object includes a plurality of media content portions and said content descriptive metadata includes portion content descriptive metadata for each of the plurality of media content portions, and further comprising at least one associated media object linked to each of the plurality of media content portions.

22. The data source of claim 17, wherein said media content comprises an interactive television program.
